(19) United States
(12) Patent Application Publication
(10) Pub. No.: US 2026/0213353 A1
(43) Pub. Date: Jul. 23, 2026

(54) WIRING MODULE

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Yuhei YAMADA, Osaka (JP); Hideo TAKAHASHI, Osaka (JP)

(21) Appl. No.: 19/141,322

(22) PCT Filed: Dec. 14, 2023
(86) PCT No.: PCT/JP2023/044806

§ 371 Date: Jun. 20, 2025

(30) Foreign Application Priority Data
Dec. 23, 2022 (JP) 2022-206507

(51) Int. Cl. H01M 50/503; B60L 50/60; B60R 16/02

(52) U.S. Cl. CPC H01M 50/503; B60R 16/0215; B60L 50/60; H01M 2220/20

(57) ABSTRACT

A wiring module is to be attached to a plurality of power storage elements including electrode terminals, and includes a busbar and a protector including a busbar accommodating portion for accommodating the busbar. The busbar includes electrode connecting portions to be connected to the electrode terminals, a resiliently deformable flexible portion disposed between the adjacent electrode connecting portions and a conductive portion for bringing the electrode connecting portion and the flexible portion into conduction. The conductive portion projects or is recessed from a placing surface disposed on the power storage element side of the busbar. The busbar accommodating portion includes a bottom wall disposed between the busbar and the power storage elements and facing the placing surface and an engaging portion formed on the bottom wall and to be engaged with the conductive portion.

### TECHNICAL FIELD

The present disclosure relates to a wiring module.

### BACKGROUND

Conventionally, a wiring module described in Japanese Patent Laid-Open Publication No. 2019-207825 (Patent Document 1 below) is known as a wiring module in which a plurality of power storage elements including electrode terminals are arranged in a power storage element group. This wiring module is provided with connection busbars to be connected to the electrode terminals and an insulating protector including connection busbar accommodating portions for accommodating the connection busbars. The connection busbar accommodating portions include a plurality of peripheral walls to be disposed around the connection busbars. A reinforcing portion is provided to extend between a pair of facing walls facing each other, out of the plurality of peripheral walls. The connection busbar includes a bent portion projecting in a direction separating from the electrode terminal (upward). The reinforcing portion is disposed inside the bent portion. In this way, the connection busbar can be positioned in a horizontal direction with respect to the insulating protector.

### PRIOR ART DOCUMENT

### Patent Document

Patent Document 1: JP 2019-207825 A

### SUMMARY OF THE INVENTION

### Problems to be Solved

In the above configuration, the connection busbar is configured by press-working one metal plate member. By constituting a part to be connected to an electrode and the bent portion, out of the connection busbar, by different members, the bent portion may be possibly made more flexibly resiliently deformed than the above configuration. If the bent portion is configured to be flexible in this way, it may become difficult to position the connection busbar with respect to the insulating protector by the engagement of the bent portion and the reinforcing portion.

### Means to Solve the Problem

The present disclosure is directed to a wiring module to be attached to a plurality of power storage elements including electrode terminals, the wiring module being provided with a busbar and a protector including a busbar accommodating portion for accommodating the busbar, the busbar including electrode connecting portions to be connected to the electrode terminals, a resiliently deformable flexible portion disposed between the adjacent electrode connecting portions and a conductive portion for bringing the electrode connecting portion and the flexible portion into conduction, the conductive portion projecting or recessed from a placing surface disposed on the power storage element side of the busbar, and the busbar accommodating portion including a bottom wall disposed between the busbar and the power storage elements and facing the placing surface and an engaging portion formed on the bottom wall and to be engaged with the conductive portion.

### Effect of the Invention

According to the present disclosure, it is possible to provide a wiring module capable of positioning a busbar including electrode connecting portions and a flexible portion with respect to a protector.

### BRIEF DESCRIPTION OF THE DRAWINGS

FIG. 1 is a schematic diagram showing a vehicle installed with a power storage module according to a first embodiment.

FIG. 2 is a plan view of a wiring module and power storage elements.

FIG. 3 is a perspective view of a busbar from above.

FIG. 4 is a perspective view of the busbar from below.

FIG. 5 is a side view of the busbar.

FIG. 6 is a perspective view of a busbar accommodating portion.

FIG. 7 is a plan view of the busbar accommodated in the busbar accommodating portion.

FIG. 8 is a section along A-A of FIG. 7.

FIG. 9 is a section along B-B of FIG. 7.

FIG. 10 is a section, corresponding to FIG. 8, of a wiring module according to a second embodiment.

FIG. 11 is a perspective view of a busbar accommodating portion according to the second embodiment.

### DETAILED DESCRIPTION TO EXECUTE THE INVENTION

### Description of Embodiments of Present Disclosure

First, embodiments of the present disclosure are listed and described.
(1) The wiring module of the present disclosure is to be attached to a plurality of power storage elements including electrode terminals, and provided with a busbar and a protector including a busbar accommodating portion for accommodating the busbar, the busbar including electrode connecting portions to be connected to the electrode terminals, a resiliently deformable flexible portion disposed between the adjacent electrode connecting portions and a conductive portion for bringing the electrode connecting portion and the flexible portion into conduction, the conductive portion projecting or recessed from a placing surface disposed on the power storage element side of the busbar, and the busbar accommodating portion including a bottom wall disposed between the busbar and the power storage elements and facing the placing surface and an engaging portion formed on the bottom wall and to be engaged with the conductive portion.

According to this configuration, the busbar can be positioned with respect to the protector in a direction parallel to the placing surface by the engagement of the conductive portion projecting or recessed from the placing surface and the engaging portion formed on the bottom wall of the busbar accommodating portion.
(2) Preferably, in the wiring module of (1), the conductive portion is recessed from the placing surface, and the engaging portion projects from the bottom wall.

According to this configuration, since the conductive portion recessed from the placing surface and the engaging portion projecting from the bottom wall are engaged, the bottom wall can be formed to be thin. Therefore, the busbar accommodating portion is easily reduced in size in a direction orthogonal to the placing surface.
(3) Preferably, in the wiring module of (1) or (2), a clearance is provided between the conductive portion and the engaging portion in a direction parallel to the placing surface.

According to this configuration, manufacturing tolerances, assembly tolerances and the like of the busbar, the electrode terminals and the busbar accommodating portion in the direction parallel to the placing surface can be absorbed. Further, the flexible portion can be resiliently deformed in the direction parallel to the placing surface.
(4) Preferably, in the wiring module of (3), a plurality of the conductive portions and a plurality of the engaging portions are provided for one busbar.

According to this configuration, the rotation of the busbar in the busbar accommodating portion can be suppressed.
(5) Preferably, in the wiring module of (1) or (2), one of the conductive portion and the engaging portion is press-fit into the other.

According to this configuration, the busbar can be fixed to the busbar accommodating portion. Thus, the busbar can be positioned with respect to the protector in the direction parallel to the placing surface and the direction orthogonal to the placing surface.
(6) Preferably, in the wiring module of any one of (1) to (5), the conductive portion is formed by overlapping the electrode connecting portion, the flexible portion and a protecting member disposed to sandwich the flexible portion together with the electrode connecting portion.

According to this configuration, the damage of the flexible portion associated with the formation of the conductive portion can be suppressed by providing the protecting member.

### DETAILS OF EMBODIMENTS OF PRESENT DISCLOSURE

Hereinafter, embodiments of the present disclosure are described. The present disclosure is not limited to these illustrations, but is represented by claims and intended to include all changes in the scope of claims and in the meaning and scope of equivalents.

### First Embodiment

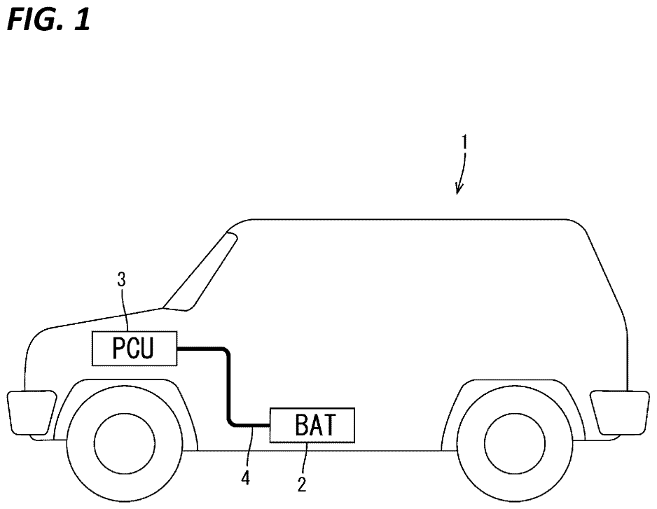

A first embodiment of the present disclosure is described with reference to FIGS. 1 to 9. A power storage module 10 provided with wiring modules 20 of this embodiment is, for example, applied to a power storage pack 2 installed in a vehicle 1 as shown in FIG. 1. The power storage pack 2 is installed in the vehicle 1 such as an electric vehicle or a hybrid vehicle and used as a drive source of the vehicle 1. In the following description, for a plurality of identical members, only some members may be denoted by a reference sign and the other members may not be denoted by the reference sign.

As shown in FIG. 1, the power storage pack 2 is disposed near a center of the vehicle 1. A PCU (Power Control Unit) 3 is disposed in a front part of the vehicle 1. The power storage pack 2 and the PCU 3 are connected by a wiring harness 4. The power storage pack 2 and the wiring harness 4 are connected by an unillustrated connector. The power storage pack 2 includes the power storage module 10 provided with a plurality of power storage elements 11. In the following description, a direction indicated by an arrow Z is referred to as an upward direction, a direction indicated by an arrow X is referred to as a forward direction and a direction indicated by an arrow Y is referred to as a leftward direction except in FIG. 1.

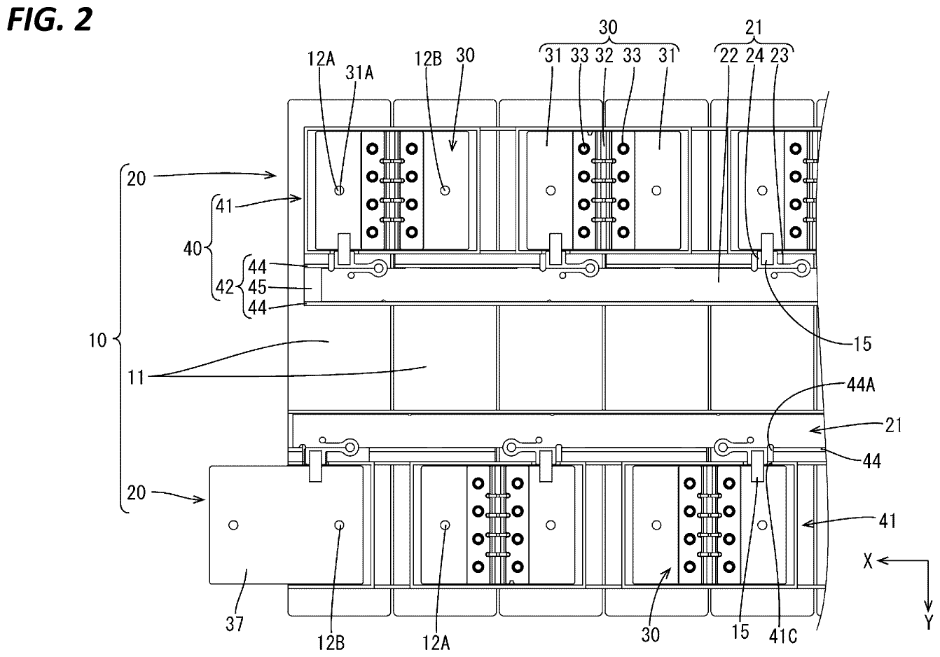

As shown in FIG. 2, the power storage module 10 is provided with the plurality of power storage elements 11 arranged in a row and the wiring modules 20 to be mounted on the upper surfaces of the plurality of power storage elements 11. The power storage element 11 has a flat rectangular parallelepiped shape and a power storage component is accommodated inside. The power storage element 11 includes positive and negative electrode terminals 12A, 12B on the upper surface.

### [Wiring Module]

The wiring module 20 is provided with busbars 30 to be connected to the power storage elements 11, a flexible board 21 to be connected to the busbars 30 and a protector 40 for holding the busbars 30 and the flexible board 21. The power storage module 10 includes the wiring module 20 to be connected to the electrode terminals 12A, 12B disposed on right sides of the plurality of power storage elements 11 and the wiring module 20 to be connected to the electrode terminals 12A, 12B disposed on left sides of the plurality of power storage elements 11, and the both wiring modules have the same configuration. For a configuration relating to a busbar accommodating portion 41, the configuration of each member is described based on the arrangement of each member in the wiring module 20 to be connected to the electrode terminals 12A, 12B disposed on the right sides of the plurality of power storage elements 11.

### [Flexible Board]

The flexible board 21 is in the form of a strip elongated in a front-rear direction as a whole. The flexible board 21 is configured by forming a plurality of voltage detection lines (not shown) on a surface of a flexible insulating sheet by a printed wiring technique. The flexible board 21 includes a board body 22, extending portions 23 extending from the board body 22 and board-side connecting portions 24 disposed on end parts of the extending portions 23.

The board body 22 is fixed to a board accommodating portion 42 of the protector 40 to be described later. Although not shown in detail, the board body 22 is, for example, provided with an insertion hole, and a projection projecting from a bottom wall 45 of the board accommodating portion 42 is inserted into this insertion hole. The extending portion 23 is formed to be long in the front-rear direction. The extending portion 23 is provided with a cut and configured to be stretchable. By providing the extending portion 23, the board-side connecting portion 24 is allowed to be displaced by a predetermined dimension with respect to the board body 22. The board-side connecting portion 24 is a part to be connected to a small metal piece 15, and one end of the unillustrated voltage detection line is disposed.

The flexible board 21 is connected to an unillustrated connector for flexible board on an end part in the front-rear direction. Terminals are accommodated inside the connector. These terminals are electrically connected to the other ends (not shown) of the voltage detection lines of the flexible board 21.

The connector is connected to an external ECU (Electronic Control Unit) or the like. The ECU is mounted with a microcomputer, elements and the like, and has a known configuration provided with functions of detecting a voltage, a current, a temperature and the like of each power storage element 11 and controlling the charge/discharge of each power storage element 11.

### [Busbar, Electrode Connecting Portions]

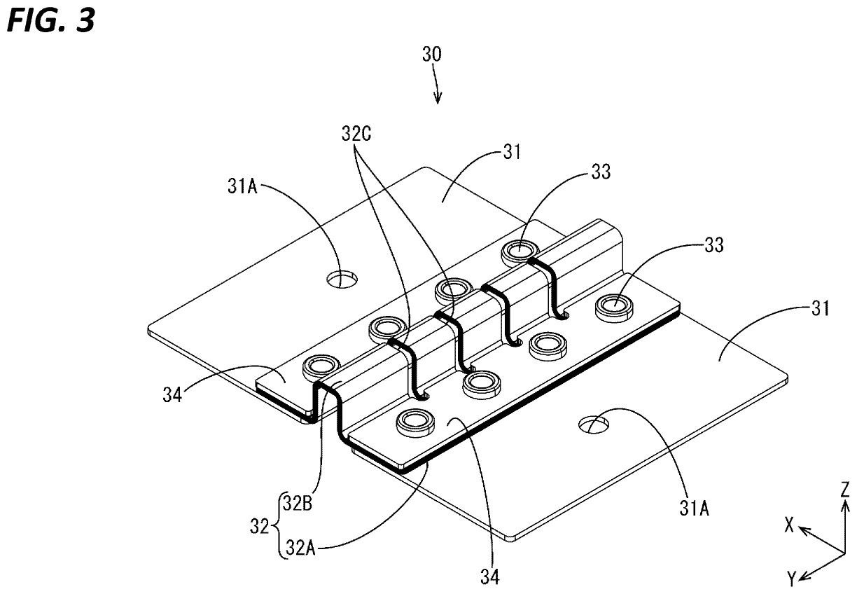

The busbar 30 connects the electrode terminals 12A, 12B of two power storage elements 11 adjacent in the front-rear direction. As shown in FIG. 3, the busbar 30 includes two electrode connecting portions 31, a flexible portion 32 disposed between the electrode connecting portions 31 and conductive portions 33 for bringing the electrode connecting portions 31 and the flexible portion 32 into conduction. The electrode connecting portion 31 is constituted by one metal plate member and is rigid. The electrode connecting portion 31 is provided with a through hole 31A penetrating through the metal plate member constituting the electrode connecting portion 31 in a vertical direction. By inserting projections provided on the electrode terminals 12A, 12B into the through holes 31A of the electrode connecting portions 31, the electrode terminals 12A, 12B and the electrode connecting portions 31 are positioned. Hole edge parts of the through holes 31A of the electrode connecting portions 31 and the electrode terminals 12A, 12B are connected by welding or the like.

### [Flexible Portion]

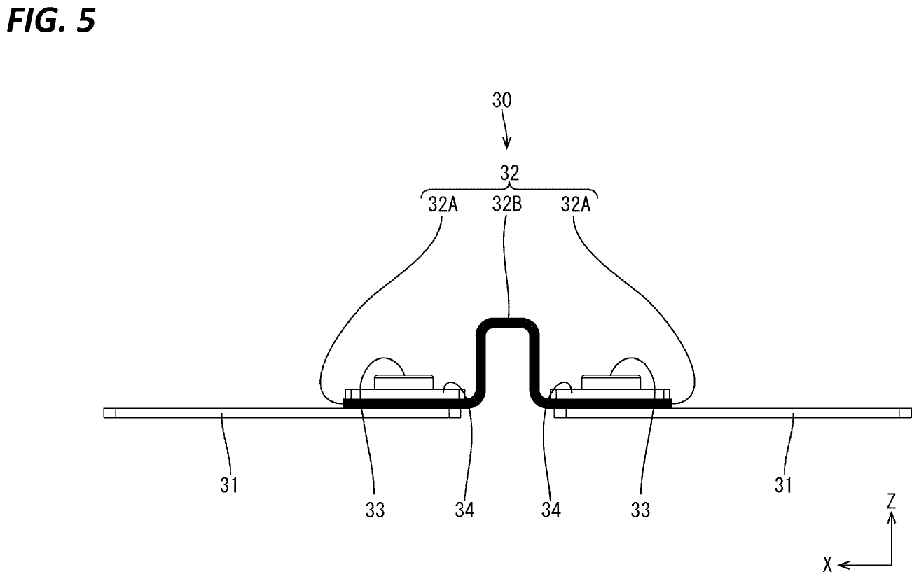

As shown in FIG. 5, the flexible portion 32 is configured by stacking a plurality of metal foils. The flexible portion 32 includes base portions 32A and a projecting portion 32B projecting upward from the base portions 32A whole forming an inverted U shape in a side view. The base portions 32A are disposed on both front and rear sides of the projecting portion 32B and overlapped on the electrode connecting portions 31. The projecting portion 32B is flexible and resiliently deformable. As shown in FIG. 3, the flexible portion 32 is provided with a plurality of (four in this embodiment) slits 32C penetrating through the projecting portion 32B and end regions of the base portions 32A adjacent to the projecting portion 32B. Each slit 32C extends in the front-rear direction. By providing the plurality of slits 32C, the flexible portion 32 is easily deformed in a lateral direction. By providing the flexible portion 32, manufacturing tolerances, assembly tolerances and the like of the busbar 30, the protector 40 and the electrode terminals 12A, 12B can be absorbed. Further, if these members expand or contract due to a temperature change, dimensional changes caused by the expansion/contraction of each are easily allowed.

### [Conductive Portions, Protecting Members]

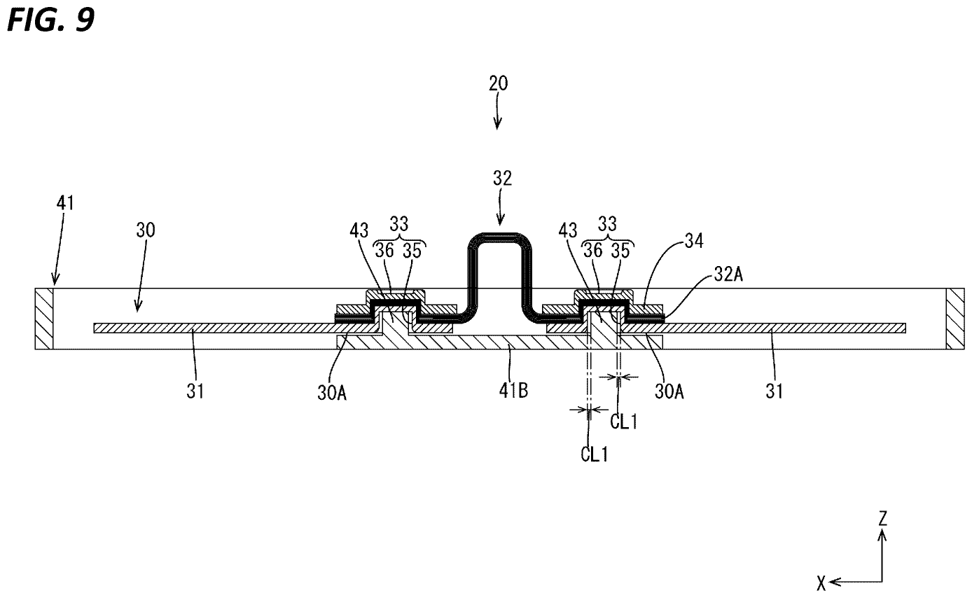

The conductive portions 33 physically and electrically connect the electrode connecting portions 31 and the flexible portion 32. As shown in FIG. 9, in this embodiment, the conductive portion 33 is formed by overlapping an end part of the electrode connecting portion 31, the base portion 32A of the flexible portion 32 and a protecting member 34 and crimping and joining these. Any of known methods may be used for crimping and joining. The base portion 32A is disposed between the protecting member 34 and the electrode connecting portion 31 in the vertical direction. As shown in FIG. 3, the protecting member 34 is a rectangular metal plate member having substantially the same front-rear dimension and lateral dimension as the base portion 32A. In this embodiment, two protecting members 34 are provided for one busbar 30, and four conductive portions 33 are provided side by side in a row in the lateral direction for one protecting member 34.

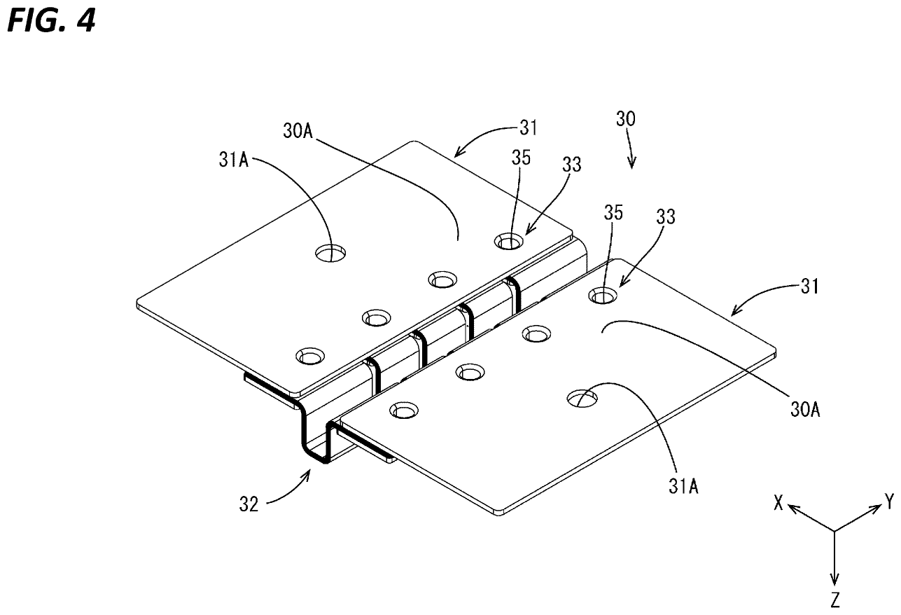

As shown in FIG. 4, the lower surface of the electrode connecting portion 31 is an end surface of the busbar 30 on the side of the power storage elements 11 (lower side), and serves as a placing surface 30A. The conductive portion 33 is formed to include a recess 35 recessed upward from the placing surface 30A. Further, as shown in FIG. 9, the conductive portion 33 includes a protrusion 36 projecting from the upper surface of the protecting member 34. The protrusion 36 is located above the recess 35. A projection amount of the protrusion 36 from the upper surface of the protecting member 34 is smaller than a depth of the recess 35 from the placing surface 30A in a substantially central part of the conductive portion 33. That is, the end part of the electrode connecting portion 31, the base portion 32A of the flexible portion 32 and the protecting member 34 stacked on each other are compressed in the substantially central part of the conductive portion 33.

As shown in FIG. 2, the electrode terminal 12A, 12B of the foremost or rearmost one of the plurality of power storage elements 11 and an external device are connected by an end busbar 37. The end busbar 37 is different from the busbars 30 described above, and constituted by one metal plate member without including the flexible portion 32 and the conductive portions 33. The end busbar 37 is fixed to an end part in the front-rear direction of the protector 40.

### [Protector]

The protector 40 is made of insulating synthetic resin. The protector 40 is provided with busbar accommodating portions 41 for accommodating the busbars 30 and a board accommodating portion 42 for accommodating the flexible board 21. The busbar accommodating portions 41 are frame-shaped and arranged side by side in the front-rear direction.

### [Busbar Accommodating Portion, Engaging Portions]

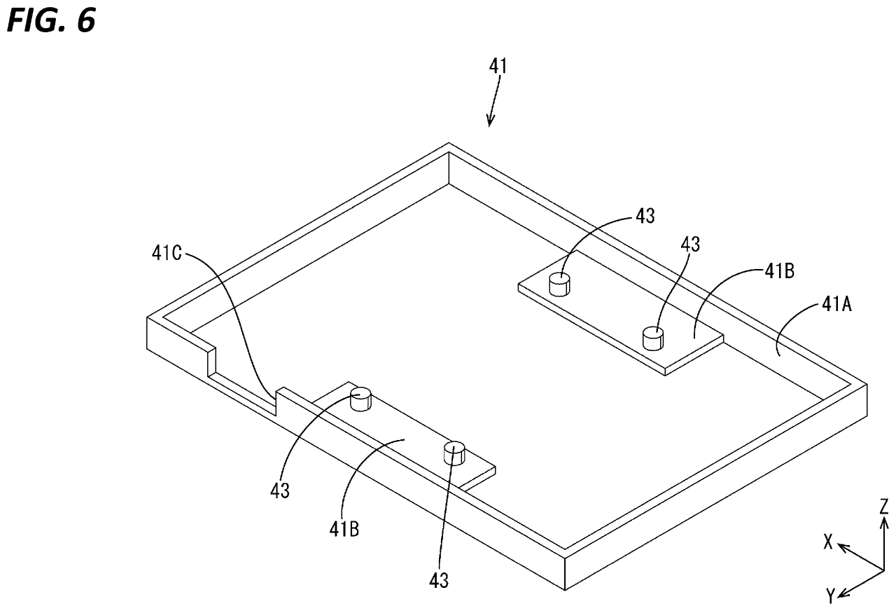

For the configuration relating to the busbar accommodating portion 41, the configuration of each member is described based on the arrangement of each member in the wiring module 20 disposed on the right sides of the plurality of power storage elements 11 as shown in FIGS. 6 to 9. As shown in FIG. 6, the busbar accommodating portion 41 includes a peripheral wall 41A and bottom walls 41B extending inwardly of the peripheral wall 41A in a horizontal direction from a lower end part of the peripheral wall 41A. A cut portion 41C is provided in a part of the peripheral wall 41A extending in the front-rear direction. In this embodiment, two bottom walls 41B are provided to extend in the lateral direction from central parts in the front-rear direction of the peripheral wall 41A. That is, the busbar accommodating portion 41 includes a pair of left and right bottom walls 41B. Each bottom wall 41B is formed with two engaging portions 43 projecting upward from the bottom wall 41B.

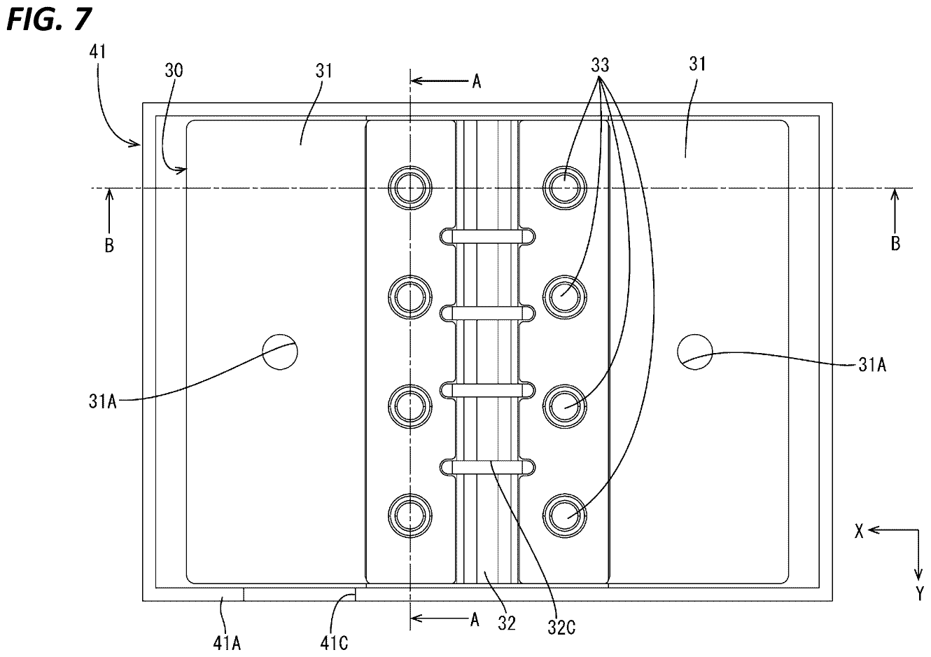

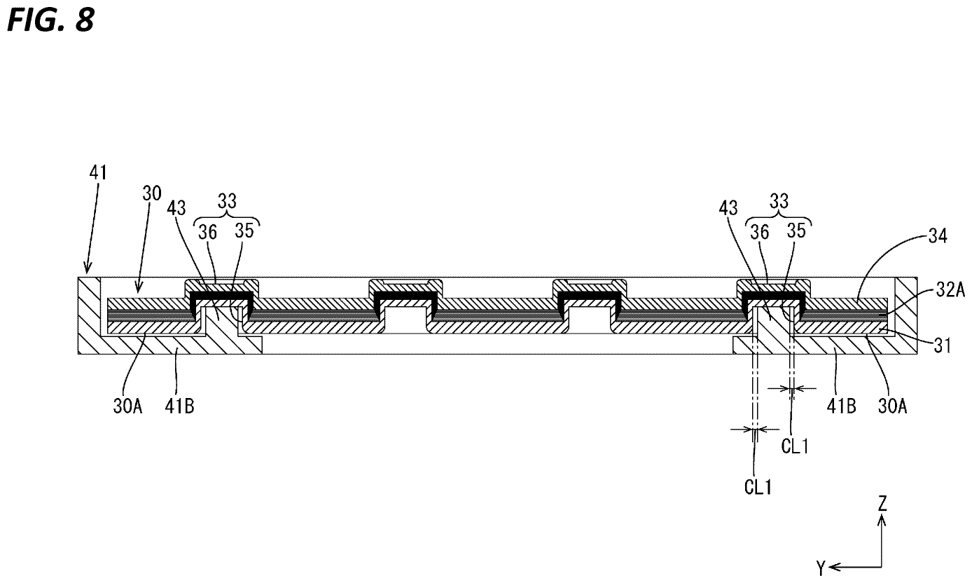

As shown in FIG. 7, the busbar 30 is accommodated inside the peripheral wall 41A of the busbar accommodating portion 41. As shown in FIGS. 8 and 9, with the busbar 30 disposed in the busbar accommodating portion 41, the placing surfaces 30A of the busbar 30 are disposed to face the bottom walls 41B. The engaging portions 43 are respectively disposed in the recesses 35 of the conductive portions 33 and engaged with the inner walls of the recesses 35. In particular, four engaging portions 43 of the busbar accommodating portion 41 are respectively engaged with two conductive portions 33 disposed on a front side and two conductive portions 33 disposed on a rear side, out of eight conductive portions 33.

A clearance CL1 is provided between the engaging portion 43 and the recess 35 in a horizontal direction. In this way, the manufacturing tolerances, the assembly tolerances and the like of the busbar 30, the protector 40 and the electrode terminals 12A, 12B can be absorbed. Further, if these members expand or contract due to a temperature change, dimensional changes caused by the expansion/contraction of each are easily allowed.

Although not shown, the peripheral wall 41A of the busbar accommodating portion 41 may be provided with a locking portion for locking the busbar 30 from above. For example, a resilient piece resiliently deformable in the horizontal direction may be provided on the peripheral wall 41A, and an end part of that resilient piece may serve as the locking portion.

As shown in FIG. 2, the board accommodating portion 42 extends in the front-rear direction and is in the form of a groove. The board accommodating portion 42 includes a pair of left and right side walls 44 and the bottom wall 45 connecting lower end parts of the pair of side walls 44. Out of the pair of side walls 44, the side wall 44 near the busbar accommodating portions 41 is provided with cut portions 44A at positions corresponding to the cut portions 41C of the busbar accommodating portions 41.

The small metal piece 15 for electrically connecting the busbar 30 and the voltage detection line of the flexible board 21 is disposed in the cut portions 41C, 44A. One end of the small metal piece 15 is electrically connected to the board side connecting portion 24, and the other end thereof is electrically connected to the busbar 30. The small metal piece 15 and the board-side connecting portion 24 are connected, for example, by soldering. The small metal piece 15 and the busbar 30 are connected, for example, by welding.

### Functions and Effects of First Embodiment

According to the first embodiment, the following functions and effects are achieved.

The wiring module 20 according to the first embodiment is to be attached to the plurality of power storage elements 11 including the electrode terminals 12A, 12B, and provided with the busbars 30 and the protector 40 including the busbar accommodating portions 41 for accommodating the busbars 30. The busbar 30 includes the electrode connecting portions 31 to be connected to the electrode terminals 12A, 12B, the resiliently deformable flexible portion 32 disposed between the adjacent electrode connecting portions 31 and the conductive portions 33 for bringing the electrode connecting portions 31 and the flexible portion 32 into conduction. The conductive portion 33 is recessed or projects from the placing surface 30A of the busbar 30 disposed on the side of the power storage element 11. The busbar accommodating portion 41 includes the bottom walls 41B disposed between the busbar 30 and the power storage elements 11 and facing the placing surfaces 30A and the engaging portions 43 formed on the bottom walls 41B and to be engaged with the conductive portions 33.

According to this configuration, the busbar 30 can be positioned with respect to the protector 40 in a direction parallel to the placing surfaces 30A by engaging the conductive portions 33 recessed or projecting from the placing surfaces 30A and the engaging portions 43 formed on the bottom walls 41B of the busbar accommodating portion 41.

In the first embodiment, the conductive portions 33 are recessed from the placing surfaces 30A and the engaging portions 43 project from the bottom walls 41B.

According to this configuration, since the conductive portions 33 recessed from the placing surfaces 30A and the engaging portions 43 projecting from the bottom walls 41B are engaged, the bottom walls 41B can be formed to be thin. Thus, the busbar accommodating portion 41 is easily reduced in size in a direction orthogonal to the placing surfaces 30A.

In the first embodiment, the clearance CL1 is provided between the conductive portion 33 and the engaging portion 43 in the direction parallel to the placing surface 30A.

According to this configuration, the manufacturing tolerances, the assembly tolerances and the like of the busbar 30, the electrode terminals 12A, 12B and the busbar accommodating portion 41 in the direction parallel to the placing surfaces 30A can be absorbed. Further, the flexible portion 32 can be resiliently deformed in the direction parallel to the placing surfaces 30A.

In the first embodiment, a plurality of the conductive portions 33 and a plurality of the engaging portions 43 are provided for one busbar 30.

According to this configuration, the rotation of the busbar 30 in the busbar accommodating portion 41 can be suppressed.

In the first embodiment, the conductive portion 33 is formed by overlapping the electrode connecting portion 31, the flexible portion 32 and the protecting member 34 sandwiching the flexible portion 32 together with the electrode connecting portion 31.

According to this configuration, the damage of the flexible portion 32 associated with the formation of the conductive portion 33 can be suppressed by providing the protecting member 34.

### Second Embodiment

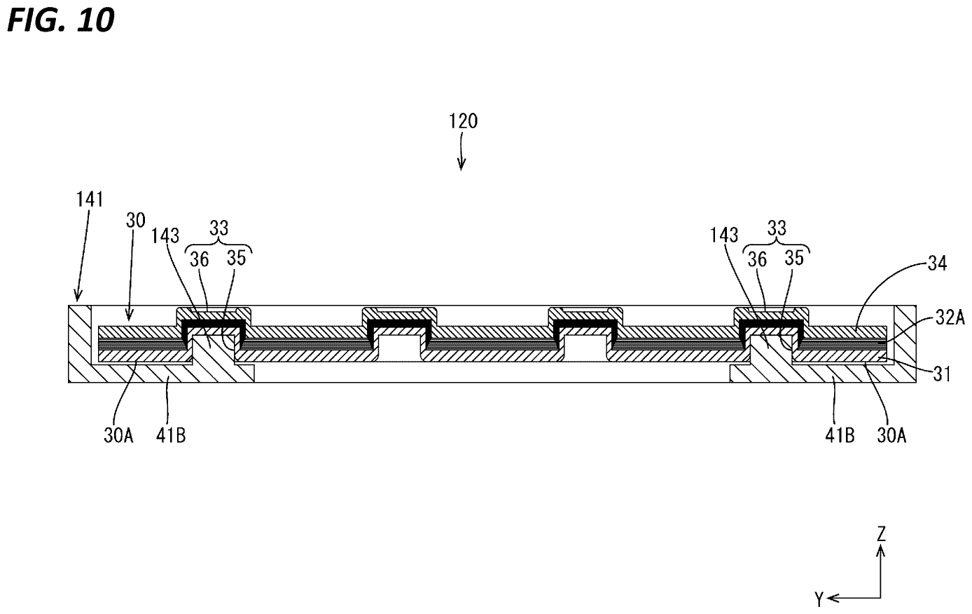

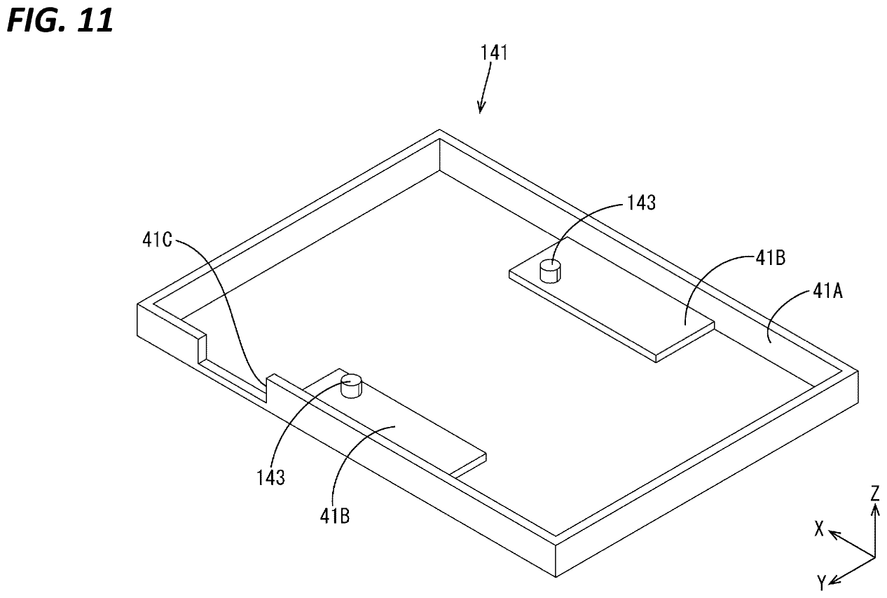

A second embodiment of the present disclosure is described with reference to FIGS. 10 and 11. Since a wiring module 120 according to the second embodiment is configured similarly to the first embodiment except the number, dimensions and the like of engaging portions 143, the same members, functions and effects as in the first embodiment are not described. Note that, for a plurality of identical members, only some members may be denoted by a reference sign and the other members may not be detected by the reference sign.

As shown in FIG. 11, each of a pair of bottom walls 41B of a busbar accommodating portion 141 is formed with one engaging portion 143. That is, two engaging portions 143 are provided for one busbar accommodating portion 141. These two engaging portions 143 are disposed at positions near one side in the front-rear direction. An outer diameter of the engaging portion 143 is larger than an inner diameter of a recess 35. Thus, in this embodiment, the engaging portion 143 is press-fit into the recess 35 (see FIG. 10). That is, the clearance CL1 of the first embodiment is not provided in this embodiment.

Further, in this embodiment, the two engaging portions 143 are press-fit into the recesses 35 of conductive portions 33 connecting one (front one in this embodiment) electrode connecting portion 31, out of two electrode connecting portions 31 of a busbar 30, and a base portion 32A. Thus, the one of the two electrode connecting portions 31 of the busbar 30 is fixed to the busbar accommodating portion 141. Therefore, a flexible portion 32 is allowed to be resiliently deformed in the front-rear direction, the lateral direction and the vertical direction. That is, the other electrode connecting portion 31 is displaceable in the front-rear direction, the lateral direction and the vertical direction with respect to the one electrode connecting portion 31, out of the two electrode connecting portions 31 of the busbar 30.

Since the electrode connecting portion 31 is fixed to the busbar accommodating portion 141 in this embodiment, the busbar 30 can be restricted from moving upward with respect to the busbar accommodating portion 141 even if the busbar accommodating portion 141 is not provided with a locking portion for locking the busbar 30 from above.

### Functions and Effects of Second Embodiment

According to the second embodiment, the following functions and effects are achieved.

In the second embodiment, the engaging portions 143 are press-fit into the conductive portions 33.

According to this configuration, the busbar 30 can be fixed to the busbar accommodating portion 141. Thus, the busbar 30 can be positioned with respect to a protector 40 in a direction parallel to placing surfaces 30A and a direction orthogonal to the placing surfaces 30A.

### Other Embodiments

(1) Although the conductive portions 33 are recessed from the placing surfaces 30A and the engaging portions 43, 143 project from the bottom walls 41B in the first and second embodiments, there is no limitation to this and conductive portions may project from placing surfaces and engaging portions may be formed to be recessed from bottom walls. Further, in this case, the engaging portions may be the inner walls of holes formed to penetrate through the bottom walls.
(2) Although eight conductive portions 33 are provided for one busbar 30 and four engaging portions 43 are provided for one busbar accommodating portion 41 in the above first embodiment, there is no limitation to this and the number of the conductive portions for one busbar, the number of the engaging portions for one busbar accommodating portion, a positional relationship of the conductive portions and the engaging portions and the like may be changed as appropriate. If the engaging portions 143 are press-fit into the recesses 35 of the conductive portions 33 as in the second embodiment, a press-fitting structure of the conductive portion and the engaging portion is preferably arranged at a position near one of two electrode connecting portions of a busbar.
(3) Although the busbar 30 is provided with two electrode connecting portions 31 and one flexible portion 32 in the first and second embodiments, there is no limitation to this. For example, if a busbar connects power storage elements in parallel, the busbar may include n electrode connecting portions and (n−1) flexible portions when n is an integer equal to or greater than 3.
(4) Although the flexible portion 32 is configured by stacking a plurality of metal foils and includes the slits 32C extending in the front-rear direction in the first and second embodiments, the form of a flexible portion is not limited if the flexible portion is configured to be resiliently deformed. For example, the flexible portion may include no slits. Further, the flexible portion may be constituted by a wire or the like.
(5) Although the flexible board 21 is used as the voltage detection lines in the first and second embodiments, there is no limitation to this. For example, as the voltage detection lines, wires may be used or wires and a flexible board may be used.
(6) Although the busbar 30 and the flexible board 21 are electrically connected via the small metal piece 15 in the first and second embodiments, there is no limitation to this and a busbar and a flexible board may be directly connected by welding, soldering or the like.

List of Reference Numerals

| | |
|---|---|
| 1: | vehicle |
| 2: | power storage pack |
| 3: | PCU |
| 4: | wiring harness |
| 10: | power storage module |
| 11: | power storage element |
| 12A, 12B: | electrode terminal |
| 15: | small metal piece |
| 20: | wiring module |
| 21: | flexible board |
| 22: | board body |
| 23: | extending portion |
| 24: | board-side connecting portion |
| 30: | busbar |
| 30A: | placing surface |
| 31: | electrode connecting portion |
| 31A: | through hole |
| 32: | flexible portion |
| 32A: | base portion |
| 32B: | projecting portion |
| 32C: | slit |
| 33: | conductive portion |
| 34: | protecting member |
| 35: | recess |
| 36: | protrusion |
| 37: | end busbar |
| 40: | protector |
| 41, 141: | busbar accommodating portion |
| 41A: | peripheral wall |
| 41B: | bottom wall |
| 41C: | cut portion |
| 42: | board accommodating portion |
| 43, 143: | engaging portion |
| 44: | side wall |
| 44A: | cut portion |
| 45: | bottom wall |
| 120: | wiring module |
| CL1: | clearance |

1. A wiring module to be attached to a plurality of power storage elements including electrode terminals, comprising:
a busbar; and
a protector including a busbar accommodating portion for accommodating the busbar,
the busbar including electrode connecting portions to be connected to the electrode terminals, a resiliently deformable flexible portion disposed between the adjacent electrode connecting portions and a conductive portion for bringing the electrode connecting portion and the flexible portion into conduction,
the conductive portion projecting or recessed from a placing surface disposed on the power storage element side of the busbar, and
the busbar accommodating portion including a bottom wall disposed between the busbar and the power storage elements and facing the placing surface and an engaging portion formed on the bottom wall and to be engaged with the conductive portion.

2. The wiring module of claim 1, wherein:
the conductive portion is recessed from the placing surface, and
the engaging portion projects from the bottom wall.

3. The wiring module of claim 1, wherein a clearance is provided between the conductive portion and the engaging portion in a direction parallel to the placing surface.

4. The wiring module of claim 3, wherein a plurality of the conductive portions and a plurality of the engaging portions are provided for one busbar.

5. The wiring module of claim 1, wherein one of the conductive portion and the engaging portion is press-fit into the other.

6. The wiring module of claim 1, wherein the conductive portion is formed by overlapping the electrode connecting portion, the flexible portion and a protecting member disposed to sandwich the flexible portion together with the electrode connecting portion.
